(19) United States
(12) Patent Application Publication
(10) Pub. No.: US 2025/0095339 A1
(43) Pub. Date: Mar. 20, 2025

(54) FUNCTIONAL SAFETY IMAGE SIGNAL PROCESSOR

(71) Applicant: NXP USA, Inc., Austin, TX (US)

(72) Inventors: Michael Andreas Staudenmaier, Munich (DE); Iani Bogdan Almajan, Bragadiru (RO); Stephan Matthias Herrmann, Markt Schwaben (DE); Vincent Aubineau, Issy-les-Moulineaux (FR)

(21) Appl. No.: 18/813,813

(22) Filed: Aug. 23, 2024

(30) Foreign Application Priority Data
Sep. 19, 2023 (RO) A202300514

(51) Int. Cl. G06V 10/774; G06T 7/00; G06V 10/26; G06V 10/94; G06V 20/90

(52) U.S. Cl. CPC G06V 10/774; G06T 7/0002; G06V 10/273; G06V 10/955; G06V 20/90; G06T 2207/30168; G06T 2207/30248

(57) ABSTRACT

A system, method, and apparatus are provided for verifying functional safety of an image signal processor (ISP) by configuring one or more edge pattern settings in a test pattern generator; activating the test pattern generator to generate test pattern data by modulating a sequence of pseudo random number values with a sequence of values from an edge pattern; processing the test pattern data at the ISP to generate ISP test output data; generating a checksum value of the ISP test output data; and comparing the checksum value with a reference checksum value to verify a functionality of the ISP.

### BACKGROUND

### Field

This disclosure is directed in general to the field of image processing. In one aspect, the disclosure relates to functional safety measures for image signal processing apparatus, system and method for operating same.

### Description of the Related Art

In safety critical environments, the integrity of image signal processing performed on image data must be ensured. For example, computer vision systems are increasingly used in automotive applications (e.g., Advanced Driver Assistance System (ADAS), surveillance, inspection, security, and remote sensing systems) where the integrity of the image signal processing can be vitally important to the safe operation of vehicles. There are existing approaches for ensuring image signal processing integrity, they are not well suited for such computer vision system applications. For example, human reviewers can evaluate image data errors and even correctly interpret pictures which have some pixel errors, but human evaluation is not suitable from a functional safety perspective when applied to computer vision applications. And while computer vision applications can apply machine vision and machine learning technologies to perform a high level analysis which detects error features in the image data by generating a checksum of the displayed image data, such approaches require a priori knowledge of the image data to generate a reference checksum value that may not be readily available with real time image processing applications. While generating a checksum is in fact a relatively cheap operation, the challenge is that the reference checksum (i.e., what is correct) is not available as the image is coming from a camera taking an exposure from an unknown scene even adding random noise to it. As seen from the foregoing, existing image signal processing (ISP) hardware for performing camera data pre-processing does not include practical functional safety mechanisms such as are increasingly required to comply with Automotive Safety Integrity Level B (ASIL-B) protocols defined by the ISO 26262 standard and are extremely difficult at a practical level by virtue of the challenges with quickly and efficiently providing functionally save image signal processing solutions because of the difficulties of meeting the real time performance requirements when performing image signal processing.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 depicts a simplified schematic block diagram of a functionally safe image signal processor in accordance with selected embodiments of the present disclosure.

FIG. 2 depicts a simplified schematic block diagram of an enhanced pseudo random number generator in accordance with selected embodiments of the present disclosure.

FIG. 3 depicts a simplified schematic block diagram of a first edge pattern generator in accordance with selected embodiments of the present disclosure.

FIG. 4 depicts a simplified schematic block diagram of a second edge pattern generator in accordance with selected embodiments of the present disclosure.

FIG. 5 illustrates an example advanced edge pattern in accordance with selected embodiments of the present disclosure.

FIG. 6 depicts a simplified flow chart showing the processing steps for operating a functionally safe image signal processor in accordance with selected embodiments of the present disclosure.

FIG. 7 is a graphical view of an example of a raster scan.

FIG. 8 is a graphical view of synchronization pulses of an image sensor to illustrate the different phases which can be used to operate a functionally safe image signal processor in accordance with selected embodiments of the present disclosure.

FIG. 9 depicts a simplified schematic block diagram of a computer system in accordance with selected embodiments of the present disclosure.

### DETAILED DESCRIPTION

A camera ISP hardware apparatus, system, architecture, methodology, and program code are described for providing functional safety verification of the camera ISP hardware by periodically testing the functionality of the camera ISP hardware with an enhanced test pattern that is generated by modulating a pseudo random number with one or more defined edge pattern values so that the enhanced test pattern includes edge structures. In selected embodiments, an enhanced pseudo random number generator may be configured to generate the enhanced test pattern(s) in response to input seed values and to supply the enhanced test pattern(s) to the camera ISP hardware under test. To this end, the enhanced pseudo random number generator may include an edge pattern generator which combines (e.g., multiplies) a sequence of pseudo random numbers with a corresponding sequence of values from a defined edge pattern. In selected embodiments, the edge pattern may be pre-computed with a plurality of defined values (e.g., a “high” value and “low” value) and retrieved from memory, where the plurality of defined values are arranged in the edge pattern to define linear edge structures (e.g., cross-hatched edges, horizontal edges, vertical edges, and/or diagonal edges, etc.). In other selected embodiments, the edge pattern may be computed in real time by using a pixel clock counter to generate overflow signals to alternately select between a plurality of defined values (e.g., a “high” value and “low” value) which are applied as per-pixel scaling factors to modulate the sequence of pseudo random numbers. To verify the integrity of the camera ISP hardware, the enhanced test pattern(s) are selectively applied (e.g., during one or more synchronization phases of a raster scan display) to the camera ISP hardware, and the resulting camera ISP hardware output is used to generate a checksum value which is compared against a reference checksum value to detect an error with the camera ISP hardware.

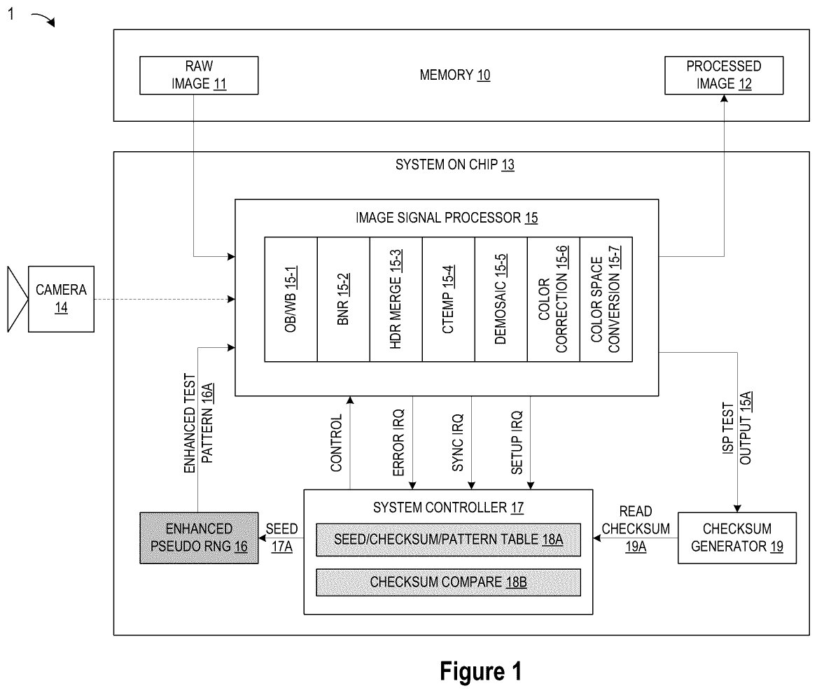

To provide additional details for an improved understanding of selected embodiments of the present disclosure, reference is now made to FIG. 1 which depicts a simplified schematic block diagram of a functionally safe image signal processing (ISP) system 1. The ISP system 1 may include a memory (e.g., storage device) 10 and a camera input device 14 connected to a System-On-A-Chip (SoC) (e.g., a semiconductor device) 13 which provides image signal processing functionality for processing raw image data 11 received from memory 10 into processed image data 12 that is stored in memory 10. Alternatively, the SoC 13 provides real-time image signal processing functionality for processing raw image data received from the input camera 14 into processed image data 12 that is stored in memory 10.

To provide the image signal processing functionality, the SoC 13 may include an image signal processing (ISP) controller 15 and a system controller 17. The ISP controller 15 may be connected and configured to receive one or more control signals (CONTROL) from the system controller 17. In addition or in the alternative, the ISP controller 15 may be connected and configured to generate an Error Interrupt Request signal (ERROR IRQ), a Sync Interrupt Request signal (SYNC IRQ), and a Setup Interrupt Request signal (SETUP IRQ) received by the system controller 17. In selected embodiments, the Error IRQ signal may indicate a buffer underrun situation, wherein the ISP controller 15 requires image data at a rate faster than the input image data is being provided to the ISP controller 15. In other embodiments, the ISP controller 15 may include one or more Error IRQ signals to flag a variety of errors. The ISP controller 15 may also generate the Sync IRQ signal which may correspond to a horizontal synch signal (HSync), a vertical sync signal (VSync) or may be a pair of connections including both the HSync and VSync signals. The ISP controller 15 may also generate the Setup IRQ signal to request the system controller 17 to provide an enhanced test pattern 16A to the ISP controller 15.

To process the input image data, the ISP controller 15 may implement digital camera image signal processing steps with an ISP pipeline hardware/module which performs a pipelined sequence of image processing operations 15-1 to 15-7. For example, the ISP pipeline hardware/module 15 may include an Optical Black/White Balance circuit (OB/WB) circuit 15-1, a Bayer Noise Reduction (BNR) circuit 15-2, a high dynamic range (HDR) circuit 15-3, a color temperature measurement (CTEMP) circuit 15-4, an image demosaic circuit 15-5, a color correction circuit 15-6, and a color space conversion circuit 15-7. However, it will be appreciated that fewer or additional image processing circuits could be used as will be appreciated by those skilled in the art, including but not limited to a synchronization circuit, a color matrix circuit, a gamma conversion circuit, an RGB conversion circuit, an edge enhancement circuit, a noise reduction circuit, a resizing circuit, a vignetting circuit, and/or an image compression/expansion circuit, and the like. Note that, although each depicted circuit 15-1 to 15-7 may serially process image data along the image data flow in the view, each circuit is allowed to separately process the image data.

To check the hardware functionality of the ISP controller 15, the system controller 17 is connected and configured to generate or retrieve an enhanced test pattern 16A that is supplied to the ISP controller 15. In response, the ISP controller 15 generates an ISP test output 15A that may be checked against a known good test result at the system controller 17. To enable efficient test result comparison, the SOC 13 may include a checksum generator 19 that is connected and configured to generate a checksum 19A from the rendered ISP test output 15A. At the system controller 17, the read checksum value 19A received from the checksum generator 19 may be compared by the checksum comparison circuit 18B with a reference checksum value that may be stored in a table 18A along with the corresponding seed value 17A that is used to generate a corresponding enhanced test pattern. If the checksum comparison circuit 18B detects a failed comparison of the read checksum value 19A with the reference checksum value, this may indicate a fault with the functionality of the ISP controller 15. In selected embodiments, the checksum generator 19 may generate a checksum value 19A based on the enhanced test pattern data 16A, and the system controller 17 may similarly compare the read checksum value 19A to a previous checksum based on the corresponding subset of the enhanced test pattern data 16A.

In selected embodiments, the reference checksum value may be precomputed or defined offline during an initialization phase prior to checking the hardware functionality of the ISP controller 15. Advantageously, a predefined reference checksum guards against a permanent fault that may exist when the ISP controller 15 is initially activated or powered-on. In selected embodiments, the predefined reference checksum is determined during development of the functionally safe ISP controller 15 using one or more parameters including without limit, a seed value of a pseudo random number generator and a configuration of the ISP controller 15. In another embodiment, more than one predefined reference checksum value may be stored in the table 18A based on more than one seed value or ISP controller configuration or enhanced test pattern.

To generate the enhanced test pattern 16A, the system controller 17 may be connected and configured to provide a seed value 17A to an enhanced pseudo random number generator 16 which computes the enhanced test pattern 16A in real time by using a pixel clock counter to generate overflow signals to alternately select between a plurality of defined values (e.g., a “high” value and “low” value), thereby generating an edge pattern where the plurality of defined values (e.g., a “high” value and “low” value) are arranged in the edge pattern to define linear edge structures (e.g., cross-hatched edges, horizontal edges, vertical edges, and/or diagonal edges, etc.). Though not shown, it will be appreciated that, in other selected embodiments, the system controller 17 may retrieve a pre-computed edge pattern from memory 10, where the pre-computed edge pattern may include a plurality of defined values (e.g., a “high” value and “low” value) arranged in the edge pattern to define linear edge structures (e.g., cross-hatched edges, horizontal edges, vertical edges, and/or diagonal edges, etc.). Regardless of how the edge pattern is obtained, the enhanced pseudo random number generator 16 sequentially applies values from the edge pattern as per-pixel scaling factors to modulate a sequence of pseudo random numbers that are generated from the seed value 17A, thereby generating the enhanced test pattern 16A to include edge structures. In this way, the test pattern 16 is enhanced in comparison to conventional test patterns which may simply be generated as a sequence of pseudo random numbers, and therefore do not include edge structures. In contrast, the use of edge patterns to modulate data generated by a pseudo random number generator will provide improved functional coverage of an ISP controller 15 due to the fact that the edge pattern-modulated PRNs include edge processing structures.

As disclosed herein, the ISP controller 15 may periodically (or on a predetermined basis) process enhanced test pattern 16A that is generated and supplied by the enhanced pseudo random number generator 16. The generated ISP test output 15A is fed into a checksum generator 19 (e.g., CRC block) which condenses the output into one representative value that can be easily checked. As the enhanced pseudo random number generator 16 generates the same random numbers for a given input seed value 17A, the resulting enhanced test pattern 16A is known, as is the expected correct ISP test output 15A which can be used as the comparison value in order to detect correct/faulty behavior of the ISP controller 15.

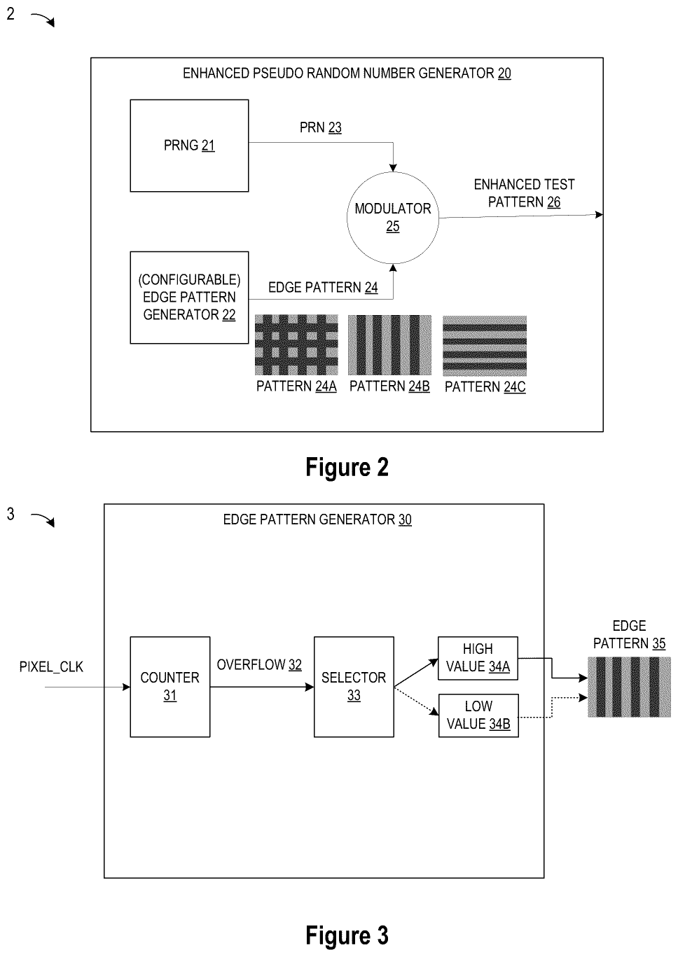

To provide additional details for an improved understanding of selected embodiments of the present disclosure, reference is now made to FIG. 2 which depicts a simplified schematic block diagram 2 of an enhanced pseudo random number generator 20. As depicted, the enhanced pseudo random number generator 20 includes a pseudo random number generator 21 which generates a sequence of pseudo random number (PRN) values 23, and also includes an edge pattern generator 22 which generates an edge pattern 24. In addition, the enhanced pseudo random number generator 20 includes a modulator 25 which combines the PRN values 23 with the edge pattern 24 values to generate the enhanced test pattern output 26. In selected embodiments, the modulator 25 may be implemented as a multiplier which applies a sequence of values from the edge pattern 24 as per-pixel scaling factors to modulate a corresponding sequence of PRN values 23. By overlaying the PRN values 23 with values from the edge pattern 24 which define a patterned grid, the resulting enhanced test pattern 26 incorporates edges while retaining pseudo random numbers, at least in weighted form.

In selected embodiments, the edge pattern generator 22 may be implemented as a configurable edge pattern generator which is configured to generate any of a plurality of edge patterns (e.g., 24A-C) which may include defined linear edge structures. For example, the first edge pattern 24A includes cross-hatched edges. In addition, the second edge pattern 24B includes vertical edges. In addition, the third edge pattern 24C includes horizontal edges. As will be appreciated, any suitable edges structures (e.g., diagonal edges) can be generated by configuring the edge pattern generator 22 to select or generate an edge pattern 24. In the visualization shown in FIG. 2, the edge pattern(s) 24 can be generated by selecting a first value (e.g., close to or equal to 1.0) for the gray areas by selecting a very small value (e.g., 0.1) for the dark areas. Referring back to FIG. 1, each selected edge pattern 24 may have a pattern ID value that is stored in the table 18A with a corresponding seed value and associated reference checksum value. In this way, when the seed value from a table entry 18A is provided to the pseudo random number generator 21 and the pattern ID value is provided to the edge pattern generator 22, the resulting enhanced test pattern 26 is supplied to the ISP controller 15, and the resulting ISP test output 15A is causes the checksum generator 19 to generate a read checksum value 19A that may be compared by the checksum comparison circuit 18B to the corresponding reference checksum value from the table entry 18A.

To provide additional details for an improved understanding of selected embodiments of the present disclosure, reference is now made to FIG. 3 which depicts a simplified schematic block diagram 3 of a first edge pattern generator 30. As depicted, the edge pattern generator 30 includes a pixel clock counter 31 which generates an overflow signal 32 in response to a predetermined or configurable number of pixel clock pulses being received. In addition, the edge pattern generator 30 includes a selector circuit 33 which responds to each overflow signal 32 by alternating the selection of at least a first “high” value 34A and a second “low” value 34B for output to form the edge pattern 35. In operation, the input pixel clock signal is used to indicate whenever the next value is required from the edge pattern generator 30 by using the pixel clock counter 31 to keep track of the number of values generated and to generate the overflow signal 32 when the counter reaches a configurable or set overflow value (e.g., 32 pixels). Alternatively, the pixel clock counter 31 may have a configurable upper value and may be reset whenever it reaches the upper value. Whenever an overflow/reset happens, the selector 33 then selects either the first “high” value 34A or second “low” value 34B for output as the edge pattern 35. For example, if the counter 31 overflows at 32 pixel clock pulses, then the selector 33 may select the first “high” value 34A for output to the edge pattern 35 for the first 32 pixel clock pulses, but upon overflow, the selector 33 then selects the second “low” value 34B for output to the edge pattern 35 for the next 32 pixel clock pulses, and so on. In the example edge pattern 35, the line width is a multiple of the overflow value, so the top line of the edge pattern 35 alternates between 32 “high” and 32 “low” values, resulting in the vertical line or grid pattern if there is no offset between different lines. If an offset is included between each line, then the edge pattern 35 has a diagonal line or grid pattern. And if the line width equals the overflow value, then the edge pattern 35 is generated with a horizontal line or grid pattern. Alternatively, a horizontal line or grid pattern can be generated when the overflow value is one or multiple of the line width. If the overflow value=1, then the color for each line is switched between 34A/34B. In case the overflow value=2, the alternating happens every second line and so on. However, the edge pattern generator 30 is not able to generate edge patterns with both vertical and horizontal edge structures.

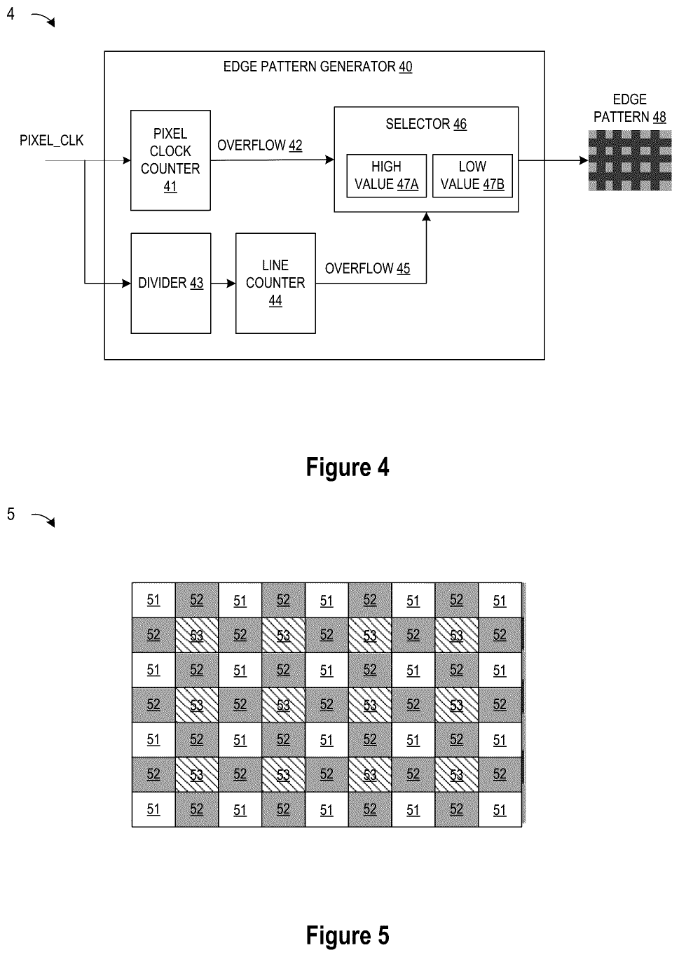

To provide additional details for an improved understanding of selected embodiments of the present disclosure, reference is now made to FIG. 4 which depicts a simplified schematic block diagram of a second edge pattern generator 40. As depicted, the edge pattern generator 40 includes a pixel clock counter 41 which generates a first overflow signal 42 in response to a predetermined or configurable number of pixel clock pulses being received. In addition, the edge pattern generator 40 includes a divider circuit 43 that is connected to receive the input clock signal, and to provide the divided pixel clock signal to a line counter 44 which generates a second overflow signal 45 for tracking the different lines of the edge pattern 48. In response to the first and second overflow signals 42, 45, the edge pattern generator 40 includes a selector circuit 46 which, depending on the line of the edge pattern 48, alternately selects between at least a first “high” value 47A and a second “low” value 47B for output to form the edge pattern 48. In operation, the input pixel clock signal is counted by the pixel clock counter 41 to generate the overflow signal 42 when generating a first line of the edge pattern 48 so that, whenever an overflow/reset happens, the selector 46 alternately selects between the first “high” value 47A and second “low” value 47B for output in the first line of the edge pattern 48. However, when the line counter 44 detects a new line, the second overflow signal 45 prompts the selector 46 to select only the first “high” value 47A for the entire line of the edge pattern 48, before reverting back to alternating the selection of “high” and “low” values 47A, 47B with the next line in response to the first overflow signal 42. As seen from the foregoing, the second overflow signal 45 generated by the line counter 44 is used to decide whether the “high” or “low” values 47A, 47B are output. As a result, the selector logic 46 generates “high” value 47A at alternating lines of the edge pattern 48, regardless of whether there is a vertical high area or a horizontally high area. In selected embodiments, two flip-flops may be used to keep track of the state in combination with a logical OR.

As disclosed hereinabove, the edge patterns may be generated by selectively choosing between two distinct values, such as the “high” or “low” values 47A, 47B. However, it will be appreciated that edge patterns may also be generated from three or more distinct values. For example, reference is now made to FIG. 5 which illustrates an example advanced edge pattern 5 wherein a third distinct, higher value is generated for defined regions in the edge pattern 5 that are “high” from both a horizontal and vertical perspective could be given a higher value in order to get a better variation. In this example, the edge pattern 5 has alternating regions in the outer rows and columns that alternate between a first “low” value 51 and a second “high” value 52. However, in the interior rows of the edge pattern 6, a third “higher” value 53 is output for any region which is surrounded both vertically and horizontally by “high” value regions 52.

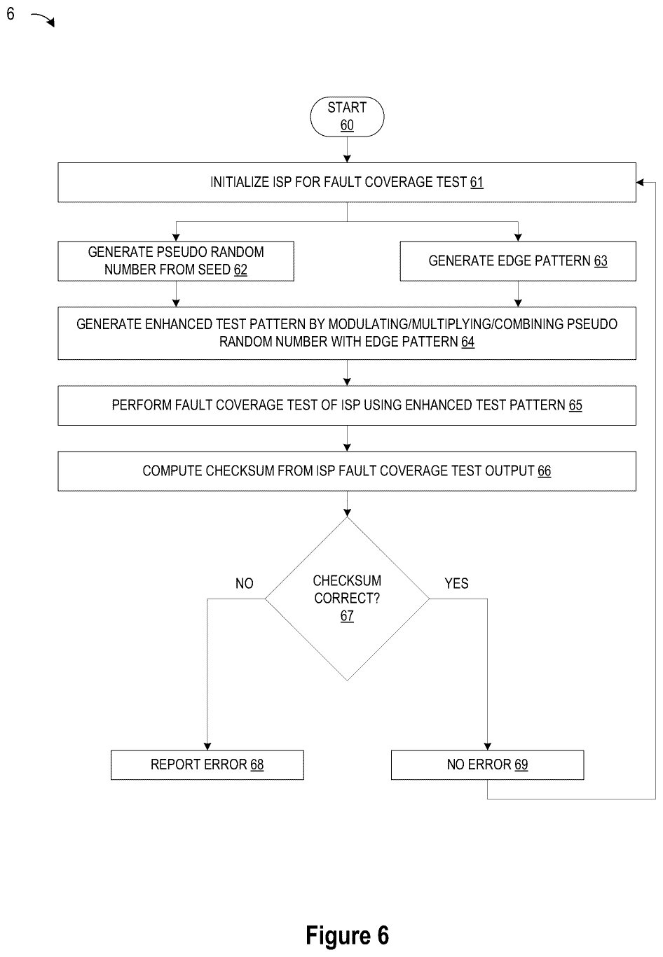

To provide additional details for an improved understanding of selected embodiments of the present disclosure, reference is now made to FIG. 6 which depicts a simplified flow chart 6 showing the processing steps 60-69 for operating a functionally safe image signal processor. In the flow diagram 6, the method starts at step 60, such as when a camera stream processing hardware unit is powered up or activated. Once activated, the ISP is initialized for fault coverage testing at step 61. In selected embodiments, the initiation step 61 defines or configures one or more edge patterns and/or enhanced test patterns for the ISP. The initiation step 61 may also specify a periodic testing schedule or test timing sequence for executing the fault coverage test.

At step 62, a pseudo random number (PRN) sequence is generated in response to an input seed value. For example, a system controller may be configured to generate a start seed for a pseudo random number generator which generates the PRN sequence. In order to reduce memory and bandwidth costs from storing PRN sequence values in memory, the PRN sequence may advantageously be computed in real time as a sequence of pseudo random numbers at any suitable PRN generator and then be sent to the ISP for processing or combination with the edge pattern values as described below.

In parallel with generating the PRN sequence, an edge pattern is generated, obtained or retrieved at step 63, though in selected embodiments, the edge pattern may be generated in whole or in part before or after the step 62. In order to reduce memory and bandwidth costs from storing edge patterns in memory, the edge pattern may advantageously be computed in real time as a sequence of values at an edge pattern generator which uses a pixel clock counter and divider circuits to generate overflow signals which control the alternating selection between a plurality of defined values (e.g., a “high” value and “low” value) for output of an edge pattern having defined linear edge structures (e.g., cross-hatched edges, horizontal edges, vertical edges, and/or diagonal edges, etc.). Once generated, the edge pattern values may then be sent to the ISP for processing or combination with the PRN sequence values as described below.

At step 64, an enhanced test pattern is generated by modulating, multiplying or combining the PRN values with the edge pattern. For example, the enhanced PRN generator may sequentially apply values from the edge pattern as per-pixel scaling factors to modulate the sequence of PRN values. As a result of overlaying the PRN values with values from the edge pattern, the resulting enhanced test pattern incorporates edges while retaining pseudo random numbers, at least in weighted form.

At step 65, the enhanced test pattern is used to perform one or more fault coverage tests of the ISP. As disclosed herein, any suitable fault coverage test may be applied which uses the enhanced test pattern as an input to the ISP and which generates an ISP fault coverage test output.

At step 66, a checksum value is computed from the ISP fault coverage test output. For example, the generated ISP fault coverage test output may be fed into a CRC block which condenses the output into one unique representative value that can be easily checked.

At step 67, the computed checksum value is checked for correctness. For example, the computed checksum value may be compared to a previously generated reference checksum value to determine an integrity measure for the ISP. If the computed checksum is correct (affirmative outcome to step 67) to indicate a match with the reference checksum, then here is “no error” (step 69) and the ISP is deemed to be functional with sufficient integrity, and the processing sequence may be repeated again later upon reinitialization of the ISP for another fault coverage test (step 61). However, if the computed checksum is not correct (negative outcome to step 67), then an error is reported (step 68). Some examples of error reporting at step 68 include, but are not limited to, setting a system flag or interrupt or activating a light or other visual or auditory signal to alert a user of the detected functional safety fault. In one example, the error is reported to a functionally higher level system, which then sets itself into a safe state.

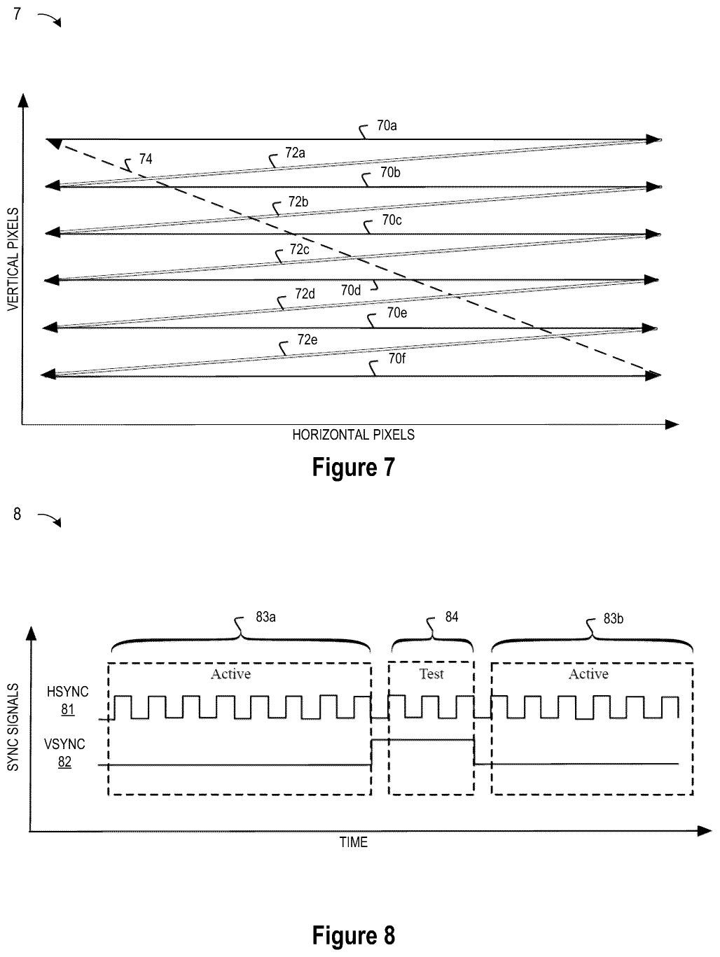

As disclosed herein, the functional coverage test of the ISP may be conducted on a predetermined or scheduled basis by periodically testing the functionality of the ISP using enhanced test patterns which are generated to include edge structures. In selected embodiments, the integrity is verified with specific test patterns that are used with tests during one or more synchronization phases of a raster scan display, thereby avoiding the requirement of testing the ISP when being actively used to generate and process image data. To illustrate the timing of functional coverage testing during one or more synchronization phase, reference is now made to FIG. 7 which depicts a graphical view of an example image with a raster scan 7 that is similar to what may be used in Cathode Ray Tube (CRT) displays. In a raster scan, serialized pixel intensity data are first displayed in the upper left corner of the image, progressing to the right along the vector 70a. After reaching the end of vector 70a, the CRT is repositioned to the left side again, and incrementing down one line, during a Horizontal Synchronization (HSync) phase 72a. The process repeats by alternating between vectors 70a, 70b, 70c, 70c, 70d, 70e and 70f (generally 70), with respective HSync phases 72a, 72b, 72c, 72d, 72e and 72f (generally 72). Once the CRT reaches the end of the last display line at the bottom right corner of the image, the display is reset to the top left starting point during a Vertical Synchronization (VSync) phase 74.

Turning now to FIG. 8, there is depicted a graphical view of synchronization pulses of an image sensor to illustrate the different phases of the ISP (active/test/active) which can be used to operate a functionally safe image signal processor in accordance with selected embodiments of the present disclosure where incoming data stream is processed directly, as opposed to retrieving image data from memory. As illustrated, the HSync pulses 81 and VSync pulses 82 correspond, respectively, with the respective HSync 72 and VSync 74 phases of FIG. 7. Specifically, during an active phase 83a or 83b, a plurality of HSync pulses 81 are generated, each one synchronizing the rastered pixel intensity data between the horizontal extremities of the display (e.g., from the left to the right in FIG. 7). It should be understood that the rastering of FIG. 7 may be mirrored in the vertical axis, horizontal axis or both with similar effect. As will be appreciated, the sync pattern of a camera is similar to the operation of a CRT display, but other types of display image processing sequences may be used in connection with the present disclosure. Pixel intensity data are transferred in the Active Area (83a) in between each of the HSync 81 pulses of FIG. 8. A test phase 84 coincides with the VSync 74 phase, during which enhanced test patterns are generated and supplied to the ISP controller for performance of fault coverage testing. In other embodiments, the enhanced test patterns are generated and transmitted during one or more of the HSync 72 pulses. In yet another embodiment, the enhanced test patterns are generated and transmitted during a combination of the one or more HSync 81 pulses and the VSync pulse 82.

Accordingly, an ISP controller may use the HSync 81 pulses, VSync pulses 82 or both the HSync and VSync pulses to process enhanced test patterns to verify the functionality of the ISP controller. By virtue of generating the enhanced test patterns to include edge features, the fault coverage tests of the ISP controller can achieve the reliability level (e.g., ASIL-B) required according to the functional safety level of the ISP controller.

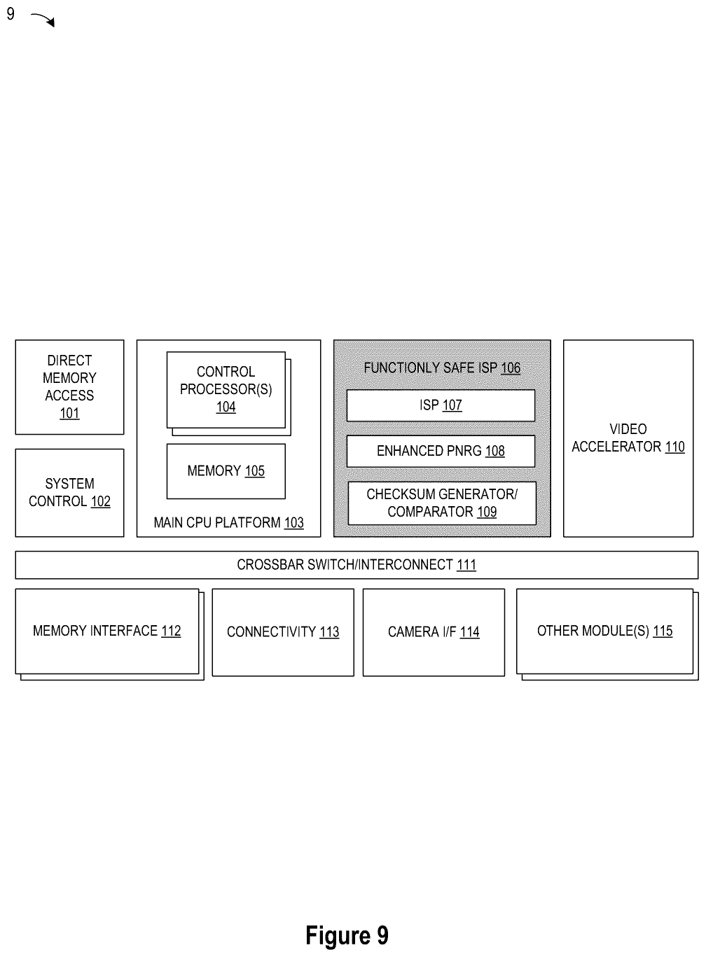

To provide additional details for an improved understanding of selected embodiments of the present disclosure, reference is now made to FIG. 9 which illustrates a simplified architectural block diagram of a microcontroller system 9 for automotive and industrial high-performance applications which implements a real-time stream camera image signal processor with a functionally safe ISP controller. As depicted, the microcontroller system 9 includes a direct memory access (DMA) block 101, a system control block 102, a main CPU platform 103, a functionally safe ISP block 106, and a video accelerator 110. In the main CPU platform 103, one or more control processor or central processing unit (CPU) subsystems 104 and on-chip memory 105 (e.g., volatile or non-volatile memory) are provided. In addition, the functionally safe ISP block 106 may include an ISP controller block 107 which processes image data, an enhanced pseudo random number generator block 108 which generates enhanced test patterns, and a checksum generator and comparator block 109 which generates checksum values based on ISP test output values that are generated by the ISP block in response to enhanced test patterns, and then compares the generated checksum values to a reference checksum value.

The DMA block 101, system control block 102, main CPU platform 103, functionally safe ISP block 106, and video accelerator 110 may be connected over an on-chip interconnect 111 to a memory interface 112 (e.g., DDR interface), one or more connectivity modules 113 (e.g., PCle 2x, FlexPWM, eTimer, IIC, DSPI, etc.), a camera interface module 114, and other modules 115. In selected embodiments, the microcontroller system 9 may be implemented as circuitry on a single integrated circuit or system-on-chip (SoC). In addition, the interconnect 111 can be any type of bus structure, including but not limited to a non-coherent interconnect, an advanced extensible interface (AXI) bus, an advanced high-performance bus (AHB), or an advanced peripheral bus (APB). In addition, the control processor(s) 104 may be any type of processing circuit, including but not limited to a microprocessor (MPU), microcontroller (MCU), digital signal processor (DSP), or another type of processor or processor core with multiple levels of cache memory. Though not shown, the microcontroller system 9 may include peripheral devices or special-purpose processors, communication interfaces, timers, encoders/decoders, and one or more external memory interfaces, such as DDR interface or flash interface. In turn, the external memory interface(s) 112 may be connected to external memory, such as DDR memory or flash memory.

As disclosed, the microcontroller system 9 may use the control processor(s) 104 to configure register settings at the functionally safe ISP block 106 individually or in combination to configure the functionally safe ISP block 106 for efficiently generating and supplying enhanced test patterns from PRN values modulated with one or more edge patterns so that the functional safety of the ISP 107 can be evaluated in compliance with ASIL-B safety protocols. In addition, by using the adaptively configurable register settings at the functionally safe ISP block 106 to enable real-time processing of the input camera stream without saving input stream frames to external memory (e.g., DDR), the bandwidth requirements, power consumption, and/or memory size requirements for external memory accesses are reduced

The term “module” may be defined to include a number of executable modules. The modules may include software, hardware or some combination thereof executable by a processor, such as the control processor(s) 104. Software modules may include instructions stored in memory, such as memory 105, or another memory device, that may be executable by the control processor(s) 104 or other processor. Hardware modules may include various devices, components, circuits, gates, circuit boards, and the like that are executable, directed, and/or controlled for performance by the control processor(s) 104.

A computer readable medium or machine readable medium may include any non-transitory memory device that includes or stores software for use by or in connection with an instruction executable system, apparatus, or device. The machine readable medium may be an electronic, magnetic, optical, electromagnetic, infrared, or semiconductor system, apparatus, or device. Examples may include a portable magnetic or optical disk, a volatile memory such as Random Access Memory “RAM”, a read-only memory “ROM”, or an Erasable Programmable Read-Only Memory “EPROM” or Flash memory. A machine readable memory may also include a non-transitory tangible medium upon which software is stored. The software may be electronically stored as an image or in another format (such as through an optical scan), then compiled, or interpreted or otherwise processed.

As will be appreciated, the term “computer readable medium” may include a single medium or multiple media, such as a centralized or distributed database, and/or associated caches and servers that store one or more sets of instructions. The computer readable medium may also include any medium that is capable of storing, encoding or carrying a set of instructions for execution by a processor or that cause a computer system to perform any one or more of the methods or operations disclosed. The computer readable medium may be non-transitory, and may be tangible. In addition, the computer readable medium may include a solid-state memory, such as a memory card or other package that houses one or more non-volatile read-only memories. The computer readable medium may be a random access memory or other volatile re-writable memory. The computer readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. As will be appreciated, any one or more of a computer readable medium or a distribution medium and other equivalents and successor media may be included for storing data or instructions.

In selected embodiments, the functionally safe ISP block 106 may be implemented with dedicated hardware, such as application specific integrated circuits, programmable logic arrays and other hardware devices, which may be constructed to implement various parts of the system. Applications that may include the apparatus and systems can broadly include a variety of electronic and computer systems. One or more examples described may implement functions using two or more specific interconnected hardware modules or devices with related control and data signals that can be communicated between and through the modules, or as portions of an application-specific integrated circuit. The system described may include software programs executable by a computer system. Implementations can include distributed processing, component/object distributed processing, and parallel processing. Alternatively, virtual computer system processing can be constructed to implement various parts of the system.

By now it should be appreciated that there has been provided an apparatus, method, program code, and system for verifying functional safety performance of an image signal processor. In the disclosed embodiments, a system controller in a system-on-chip (SoC) configures one or more edge pattern settings in a test pattern generator. In selected embodiments, the edge pattern settings may be configured by setting a configurable overflow value in a pixel clock counter to generate an overflow signal which triggers a selection circuit to switch between first and second output values when generating an edge pattern. In addition, the system controller activates the test pattern generator to generate test pattern data by modulating a sequence of pseudo random number values with a sequence of values from an edge pattern. In selected embodiments, the test pattern generator is activated by providing an input seed value to a pseudo random number generator to generate the sequence of pseudo random number values. In addition, activating the test pattern generator may include generating or obtaining the edge pattern which includes a plurality of defined values arranged in the edge pattern to define edge structures which may be linear (e.g., straight edges) or non-linear (e.g., curved edges) in different embodiments. In addition, the test pattern data may be generated by applying the sequence of values from the edge pattern as per-pixel scaling factors to modulate the sequence of pseudo random numbers. In selected embodiments, the system controller activates the test pattern generator to generate test pattern data during at least one synchronization phase of an image raster scan process. Subsequently, an image signal processor (ISP) in the SoC processes the test pattern data to generate ISP test output data from the ISP. In addition, a checksum value is generated from the ISP test output data and compared with a reference checksum value to verify a functionality of the ISP. In selected embodiments, functionality of the ISP meets at least a subset of the integrity requirements of any suitable safety standard, such as an Automotive Safety Integrity Level protocol. In selected embodiments, an error is reported in response to a difference between the checksum value and the reference checksum value. In selected embodiments, the system controller accesses a table comprising at least a first input seed value and corresponding reference checksum value.

In another form, there has been provided a system-on-chip (SoC) apparatus, method, program code, and system for verifying functional safety of an image signal processor. As disclosed, the SoC apparatus includes an image signal processor (ISP) pipeline that is connected and configure to receive and process input image data and to generate output image data. In addition, the SoC apparatus includes a checksum generator configured to generate a checksum value from the output image data. The SoC apparatus also includes a processing circuit that configures a configuration memory table with the one or more configurable edge pattern settings and corresponding input seed value and reference checksum value. The processing circuit is also configured to activate a test pattern generator to generate test pattern data by modulating a sequence of pseudo random number values with a sequence of values from an edge pattern. In selected embodiments, the test pattern generator includes a pseudo random number generator. In addition, the processing circuit may be configured to provide the input seed value to the pseudo random number generator to generate the sequence of pseudo random number values. In addition, the test pattern generator may be configured to generate or obtain the edge pattern comprising a plurality of defined values arranged in the edge pattern to define linear edge structures. In addition, the test pattern generator may be configured to apply sequence of values from the edge pattern as per-pixel scaling factors to modulate the sequence of pseudo random numbers, thereby generating the test pattern data. In addition, the test pattern generator may include a pixel clock counter that is configured with an overflow value to generate an overflow signal which triggers a selection circuit to switch between first and second output values when generating the edge pattern. In addition, the processing circuit is configured to supply the test pattern data to the ISP pipeline as input image data which is processed by the ISP pipeline to output the output image data as ISP test output data. The processing circuit is also configured to receive a checksum value generated from the ISP test output data by the checksum generator. In addition, the processing circuit is configured to compare the checksum value with the reference checksum value to verify a functionality of the ISP pipeline. In selected embodiments, the functionality of the ISP pipeline meets at least a subset of the integrity requirements of any suitable safety standard, such as an Automotive Safety Integrity Level protocol. In selected embodiments, the processing circuit is further configured to report an error in response to a difference between the checksum value and the reference checksum value.

In yet another form, there has been provided a method, apparatus, program code, and system for controlling a functional safety image signal processor. In the disclosed method, an image signal processor (ISP) test pattern is generated by modulating a plurality of pseudo random number values with a corresponding plurality of values from an edge pattern that includes edge structures. The disclosed method also supplies the ISP test pattern to an ISP pipeline as input image data which is processed by the ISP pipeline to output ISP test output data. In addition, the disclosed method generates a checksum of the ISP test output data. The disclosed method also compares the checksum with a previously generated checksum. In selected embodiments, the checksum is compared with the previously generated checksum to verify a functionality of the functional safety image signal processor. In selected embodiments, the ISP test pattern is generated by providing an input seed value to a pseudo random number generator to generate the plurality of pseudo random number values. In addition, the ISP test pattern is generated by counting pixel clock pulses with a pixel clock counter having an overflow value to generate an overflow signal whenever the pixel clock counter reaches the overflow value, thereby triggering a selection circuit to switch between first and second output values when generating the plurality of values for the edge pattern. In addition, the ISP test pattern is generated by applying the plurality of values from the edge pattern as per-pixel scaling factors to modulate the plurality of pseudo random number values.

Although the described exemplary embodiments disclosed herein focus on configuring an ISP hardware apparatus to perform fault coverage tests of an ISP using enhanced test patterns generated by modulating PRN values with defined edge patterns, the present invention is not necessarily limited to the example embodiments illustrate herein and may be applied to any image processing subsystem, as well as other subsystems, such as display controller subsystems and the like. For example, a display controller functionality may be verified by using one or more defined edge patterns to generate and render an enhanced test pattern with edge structures in a defined test area of a display device to generate rendered test data that is used to generate a checksum for comparison to a previously generated or reference checksum to verify the functionality of the display controller. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation 10 thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for verifying functional safety of an image signal processor, comprising:
configuring, by a system controller in a system-on-chip (SoC), one or more edge pattern settings in a test pattern generator;
activating, by the system controller, the test pattern generator to generate test pattern data by modulating a sequence of pseudo random number values with a sequence of values from an edge pattern;
processing, by an image signal processor (ISP) in the SoC, the test pattern data to generate ISP test output data from the ISP;
generating a checksum value of the ISP test output data;
comparing the checksum value with a reference checksum value to verify a functionality of the ISP; and
reporting an error in response to a difference between the checksum value and the reference checksum value.

2. The method of claim 1, where activating the test pattern generator to generate test pattern data comprises providing an input seed value to a pseudo random number generator to generate the sequence of pseudo random number values.

3. The method of claim 2, where activating the test pattern generator to generate test pattern data comprises generating or obtaining the edge pattern comprising a plurality of defined values arranged in the edge pattern to define edge structures.

4. The method of claim 3, where activating the test pattern generator to generate test pattern data comprises applied the sequence of values from the edge pattern as per-pixel scaling factors to modulate the sequence of pseudo random numbers.

5. The method of claim 4, where the system controller activates the test pattern generator to generate test pattern data during at least one synchronization phase of an image raster scan process.

6. The method of claim 1, where the functionality of the ISP meets at least a subset of integrity requirements of an Automotive Safety Integrity Level protocol.

7. The method of claim 1, where configuring one or more edge pattern settings in the test pattern generator comprises configuring one or more overflow values in a pixel clock counter to generate an overflow signal which triggers a selection circuit to switch between at least first and second output values when generating the edge pattern.

8. The method of claim 1, where the system controller accesses a table comprising at least a first input seed value and corresponding reference checksum value.

9. The method of claim 1, where the system controller accesses a table comprising a first pseudo random number seed value, a first set of edge generator settings for generating the edge pattern, and a corresponding a corresponding reference checksum value.

10. A system-on-chip (SoC) apparatus comprising:
an image signal processor (ISP) pipeline that is connected and configure to receive and process input image data and to generate output image data;
a checksum generator configured to generate a checksum value from the output image data; and
a processing circuit that configures a configuration memory table with the one or more configurable edge pattern settings and corresponding input seed value and reference checksum value, where the processing circuit is further configured to:
activate a test pattern generator to generate test pattern data by modulating a sequence of pseudo random number values with a sequence of values from an edge pattern;
supply the test pattern data to the ISP pipeline as input image data which is processed by the ISP pipeline to output the output image data as ISP test output data;
receive a checksum value generated from the ISP test output data by the checksum generator; and
compare the checksum value with the reference checksum value to verify a functionality of the ISP pipeline.

11. The SoC apparatus of claim 10, where the processing circuit is further configured to report an error in response to a difference between the checksum value and the reference checksum value.

12. The SoC apparatus of claim 10, where the test pattern generator comprises a pseudo random number generator.

13. The SoC apparatus of claim 12, where the processing circuit is configured to provide the input seed value to the pseudo random number generator to generate the sequence of pseudo random number values.

14. The SoC apparatus of claim 13, where the test pattern generator is configured to generate or obtain the edge pattern comprising a plurality of defined values arranged in the edge pattern to define linear edge structures.

15. The SoC apparatus of claim 14, where the test pattern generator is configured to apply sequence of values from the edge pattern as per-pixel scaling factors to modulate the sequence of pseudo random numbers.

16. The SoC apparatus of claim 10, where the functionality of the ISP pipeline meets at least a subset of the integrity requirements of an Automotive Safety Integrity Level protocol.

17. The SoC apparatus of claim 10, where the test pattern generator comprises a pixel clock counter that is configured with an overflow value to generate an overflow signal which triggers a selection circuit to switch between first and second output values when generating the edge pattern.

18. A method for controlling a functional safety image signal processor comprising:
generating an image signal processor (ISP) test pattern by modulating a plurality of pseudo random number values with a corresponding plurality of values from an edge pattern that includes edge structures;
supplying the ISP test pattern to an ISP pipeline as input image data which is processed by the ISP pipeline to output ISP test output data;
generating a checksum of the ISP test output data; and
comparing the checksum with a previously generated checksum.

19. The method of claim 18, wherein the checksum is compared with the previously generated checksum to verify a functionality of the functional safety image signal processor.

20. The method of claim 18, wherein generating the ISP test pattern comprises:
providing an input seed value to a pseudo random number generator to generate the plurality of pseudo random number values;
generating the edge pattern by counting pixel clock pulses with a pixel clock counter having an overflow value to generate an overflow signal whenever the pixel clock counter reaches the overflow value, thereby triggering a selection circuit to switch between first and second output values when generating the plurality of values for the edge pattern; and
applied the plurality of values from the edge pattern as per-pixel scaling factors to modulate the plurality of pseudo random number values.
